(19) United States
(12) Patent Application Publication
(10) Pub. No.: US 2002/0095675 A1
(43) Pub. Date: Jul. 18, 2002

(54) Providing content interruptions

(76) Inventors: Jonathan Lowthert, Sunnyvale, CA (US); Oleg B. Rashkovskiy, Cupertino, CA (US); Andray Siletsky, San Francisco, CA (US)

Correspondence Address: TROP PRUNER & HU, PC, 8554 KATY FREEWAY, SUITE 100, HOUSTON, TX, 77024, US

(21) Appl. No.: 09/765,246

(22) Filed: Jan. 18, 2001

(51) Int. Cl. H04N 7/10; H04N 7/16

(52) U.S. Cl. 725/34; 725/14

(57) ABSTRACT

Content which users may wish to receive may be distributed with interrupting content such that the use of the content on the user's receiver may be interrupted and replaced with the interrupting content. The content which the user wishes to receive may be software, audio, video, graphics or other material and the interrupting content in one embodiment of the prevent invention may be advertisements. In this way, the user's receiver may be utilized to determine when it is appropriate to interrupt the interruptible content with the interrupting content. This may provide a convenient mechanism for reduced price or free distribution of a wide variety of media currently provided only in physical form or only for free without any compensation to the content provider.

### BACKGROUND

This invention relates generally to content distribution.

Broadband content distribution may involve the distribution of television programming to a large number of receivers as well as the distribution of other forms of content. Content which may be amenable to wide spread distribution include video, graphics, software, audio and games.

The ability to charge customers for content in many cases means that the type of content that may be distributed may be of higher quality. Thus, pay-per-view television programming is widely accepted.

However, there is a considerable demand for the distribution of content without charge. Conventional television broadcasts subsidize distribution through an advertising scenario. Similarly, in connection with the Internet, a large amount of content is distributed for free with the hope that viewers will patronize advertisers that pay for banner ads that accompany the content.

Thus, it would be desirable to include advertising material or other interruptions in the course of a wide variety of content that might be distributed for free or at reduced charge in a broadband distribution network. However, many content formats are not amenable to the ready incorporation of advertising material. For example, games and software could be distributed with banner ads. However, full screen display of advertisements is generally not viable because there is no way to know when to insert these advertisements in the course of the video game or software operation.

An interruptible content delivery system allows the play of any of a variety of types of selectable content to be paused to permit the automatic insertion of advertising material. Thus, the play of audio, video, games, graphics, software or other media may be paused automatically to allow insertion of advertisements. At the end of the advertisement, the content restarts where it left off.

Generally, advertisers prefer to target their advertisements to specific demographic profiles. For example, advertisers may attempt to target a specific demographic profile based on the nature of a particular type of content such as the nature of the television program. The advertisers may determine that people who enjoy particular types of content, such as particular television programs, may be more likely to purchase particular types of products.

Advertisers, who prefer to maintain an image, may prefer to avoid having their advertisements run in conjunction with content that may have controversial aspects. Controversial aspects may include violence, language, adult situations, sexual content and the like. Thus, advertisers may prefer to target their advertisements to that content more likely to be enjoyed by the advertiser's target audience.

Of course in some potential interruptible content delivery systems, it may not be known in advance what content may be played at any given time. Instead, in many situations, the user may be in control of selecting the content that is played at any particular time. Thus, the issue arises how to insert advertisements in a fashion that may be acceptable to advertisers. In particular, it may be necessary to ensure that specific ads are associated with particular types of content either because of the type of content involved or because the advertiser may believe that particular types of audiences are more likely to be attracted to specific types of content.

Thus, there is a need for ways to enable advertising to be inserted in an interruptible content delivery system to serve the interests of advertisers.

### BRIEF DESCRIPTION OF THE DRAWINGS

FIG. 1 is a schematic depiction of a broadband digital distribution system in accordance with one embodiment of the present invention;

FIG. 2 is a flow chart for software that may be utilized on a receiver in the system shown in FIG. 1;

FIG. 3 is a block depiction of a receiver in accordance with one embodiment of the present invention; and

FIG. 4 is a flow chart for software in accordance with one embodiment of the present invention.

### DETAILED DESCRIPTION

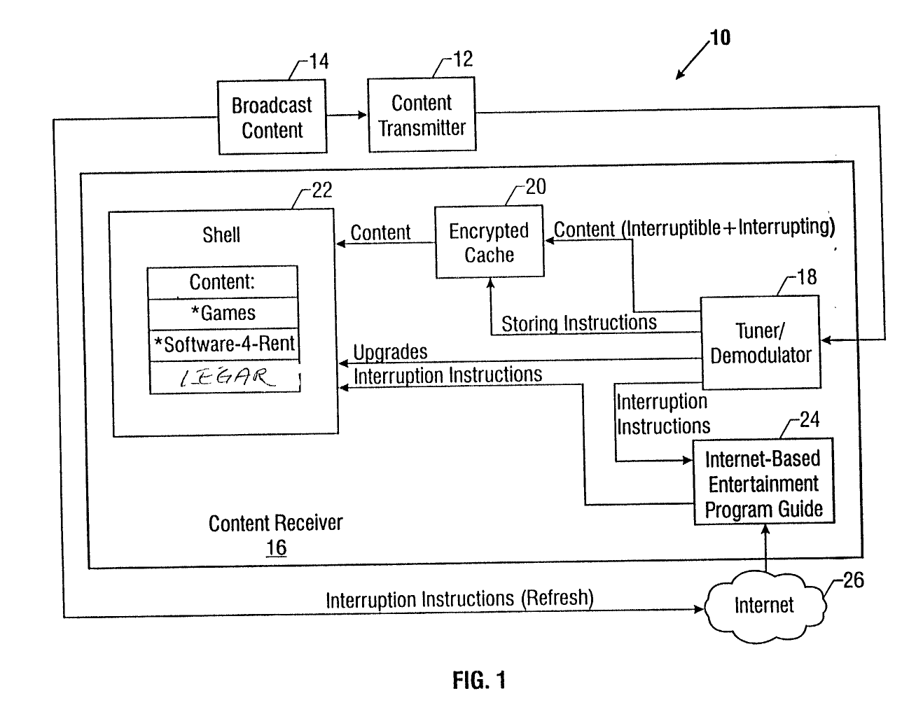

A digital broadband distribution network 10, shown in FIG. 1, may implement the distribution of a variety of content formats and the provision of content interruptions on a content receiver 16. The content receiver 16 receives content from a content transmitter 12 that in turn receives broadcast content from a content provider 14.

The content transmitted by the transmitter 12 may be made up of conventional content termed “interruptible content” and “interrupting content”. Interruptible content is content whose operation, play, or use may be interrupted for the substitution of other content. The content that is temporarily substituted for the interruptible content is called the interrupting content.

In accordance with one embodiment, interruptible content that the user desires to receive may be interrupted with interrupting content that may help to pay for the interruptible content. The interrupting content may include advertisements.

The interruptible content may be video, graphics, audio, games, and other software such as application software. The interrupting content may be substituted for the interruptible content under control of the receiver 16 in one embodiment.

The content from the content transmitter 12 is received by a tuner/demodulator 18 contained in the digital content receiver 16. The tuner/demodulator 18 tunes to one or more channels and demodulates those channels for display. In addition, the tuner/demodulator 18 may parse the interruptible and interrupting content and forward that information to an encrypted cache 20. The tuner/demodulator 18 also parses storing instructions utilized for controlling the storage of the content. The storing instructions are also forwarded to the encrypted cache 20 for use in storing the content. In addition, the tuner/demodulator 18 may parse upgrades, provided with the content, for upgrading previously received content. Finally the tuner/demodulator 18 may parse interruption instructions from the rest of the content. These interruption instructions tell when to interrupt the interruptible content with the interrupting content. The interruption instructions may be forwarded to a program guide 24.

The program guide 24 may receive interruption instructions from a back channel that may be coupled to the broadcast content provider 14. The interruption instructions may be conveyed, for example, over the Internet as indicated at 26. In some cases, the interruption instructions may be updated, revised or extended and therefore it may be necessary to convey them after the original content is received.

The program guide 24 may provide a schedule of available information that may be received from the content provider 14. This information may be accessed over the backchannel such as the Internet 26 to reduce the storage requirements on the content receiver 16. The interruption instructions, received over the back channel or as parsed by the tuner/demodulator 18, may be forwarded by the content guide 24 to a shell 22. The shell 22 in one embodiment of the present invention may be a software module that controls the use of content received from the broadcast content provider 14. Moreover, the shell 22 implements the interruption of interruptible content with interrupting content in accordance with interruption instructions received as described previously.

The encrypted cache 20 stores the content in a format that prevents decryption and theft by unauthorized individuals. The encrypted cache 20 may, for example, be part of a hard disk drive. When content is received by the system 10, the shell 22 stores the information on the hard disk drive and particularly in the encrypted cache. For example, the shell 22 may cause the content to be distributed to a variety of storage locations on the hard disk drive so that the content may not be continuously accessed in one contiguous hard drive area. Only the shell 22 can access the map that indicates where the content is stored on the hard disk drive and how it can be reconstructed to play back the content in a meaningful fashion.

Thus, as content is acquired from a source and stored through the shell into the hard disk drive, it is stored in a form that can only be accessed by the shell thereafter. To access the content one must access the content through the shell because only the shell knows where all the portions of the content are stored and how to reconstruct it in a meaningful fashion. Thus, the shell can control access in a variety of ways. For example, the shell can prevent access, the shell can provide access only in return for either watching a commercial or paying a fee or the shell may limit the number of times that the content may be viewed or even the times when the content may be viewed.

Thus, in the embodiment illustrated in FIG. 1, the shell 22 may have content, such as games or rentable software as a few examples. When the user wishes to use the content that is available from the content provider 14, the user may request a download of that information or that information may be conveyed during conditions of high bandwidth availability. Alternatively, other schemes for providing the content to the receiver 16 may be utilized. In general, the transport mechanism may include any digital mechanism such as satellite transmission, cable transmission or airwave broadcast.

Conceivably, the content may also be provided in conventional physical, portable forms such as compact disks (CD-ROM), digital video disks (DVD), flash memory or the like. The content, however received, is encoded in a way in which, absent the use of the shell 22, one would be unable to use, hear, view, play or otherwise enjoy the content. Thus, the system controls access to the content in a secure way using encryption provided with the content as conveyed over the transport media or as received in physical form by the user.

Once the information has been cached in the cache 20, the user can receive the right to enjoy, play, hear or view the content as the case may be from the shell 22. The shell 22 then releases the information for use in the appropriate format on the processor-based content receiver 16. The shell 22 may also control the number of times or the time period when the content may be used.

Moreover, the shell 22 monitors a criteria which determines when the content's use is to be interrupted with interrupting content. Thus, the shell 22 may force a mechanism wherein interrupting content may be temporarily played in place of interruptible content. For example, advertisements may be provided together with the interruptible content. Alternatively, the interrupting and interruptible content may be received at different times via different mechanisms.

For example, the interrupting content may be inserted at regular intervals. After allowing content to be played for a predetermined amount of time, interrupting content may be inserted automatically. In other cases, the interrupting content may be inserted when advantageous conditions arise. For example, in connection with gaming software, when the user reaches a stopping point, the system may determine that the action has paused sufficiently that the interrupting content may be inserted. Moreover, instead of linearly inserting the interrupting content, the content may be inserted in a progressive fashion. Thus, the more the user uses the content the higher the rate at which interrupting content may be substituted.

In one embodiment of the present invention, the content that is being played may be interrupted with the play of the commercial in real time. That is, when the commercial is broadcast over a broadcast media, it may automatically be inserted into the playback of the content on the system 10 as well.

In one embodiment of the present invention, the interruptible content may be an advertisement; however, the interrupting content may also be a request that the user make some form of payment in order to continue to use the interruptible content. For example, the receiver 16 may be called upon to access backchannel to make a payment for the continued use of the content. When the receiver 16 does so, the receiver 16 may be provided with a code either through the back channel or from the content provider which allows continued use of the interruptible content.

In some embodiments of the present invention, techniques may be utilized to reduce the likelihood that users of the system 10 will discontinue their use when the commercial is played. For example, an overlay may be provided over the commercial to indicate what is coming up next in the content. For example, where the content is a game and the commercial is inserted after the user reaches a given level, information may be provided about the next level as an overlay, for example, over the ongoing play of the commercial.

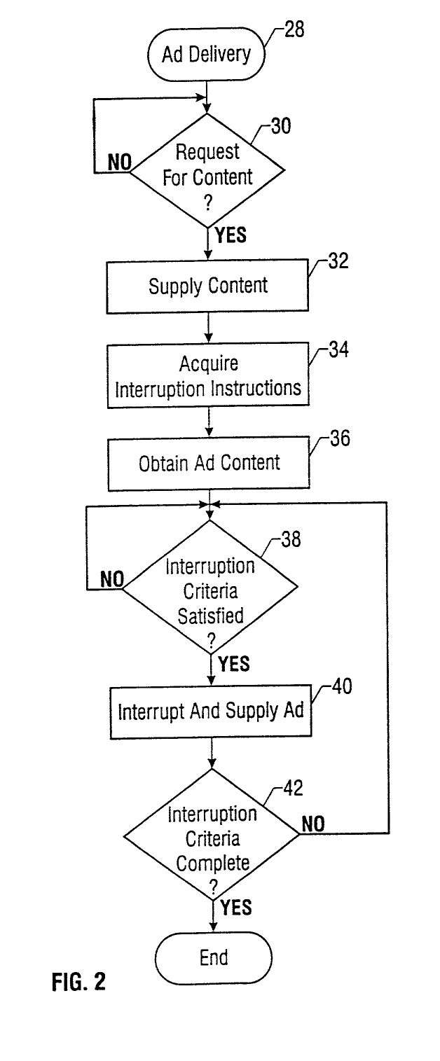

Referring to FIG. 2, the software 28 for controlling the interruption of the interruptible content may be stored on a suitable storage medium such as a hard disk drive on the receiver 16. Initially, the software 28 waits for a request for content as indicated in diamond 30. Once such a request is received, the content may be supplied as indicated in block 32. In the same process, interruption instructions may be acquired as indicated in block 34 for the content that was requested and supplied in block 32. In addition, interrupting content may then be obtained as indicated in block 36. When an interruption criteria is satisfied, as determined in diamond 38, the ongoing use of the interruptible content may be interrupted as indicated in block 40. Thus, in one embodiment of the present invention, the interruptible content is interrupted upon satisfaction of an interruption criteria. The interrupting content, such as an advertisement, is substituted temporarily.

A check at diamond 42 then determines whether the interrupted criteria is complete. If not, the flow recycles to continue to check to determine whether the interruption criteria is satisfied at diamond 38. Otherwise, the flow ends.

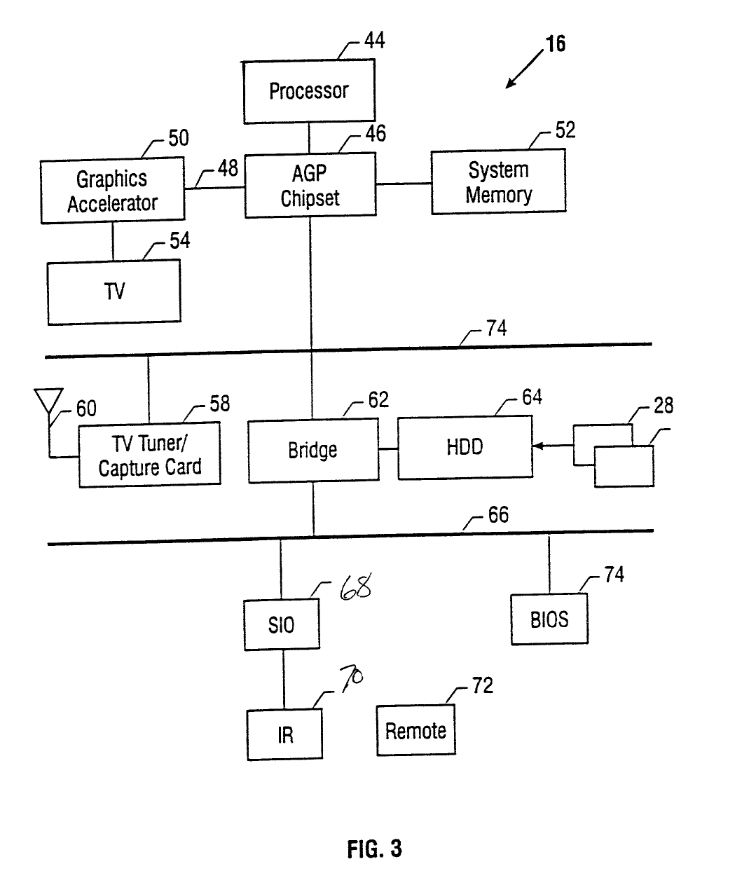

A processor-based content receiver 16 in accordance with one embodiment of the present invention shown in FIG. 3, may be a set top box, a desk top computer, an appliance, a handheld device, or other form factors. The receiver 16 may include a processor 44. In one embodiment, the processor 44 may be coupled to an accelerated graphics port (AGP) chipset 46 for implementing an accelerated graphics port embodiment. The chipset 46 communicates with the system memory 52, the AGP port 48 and the graphics accelerator 50. A television 54 may be coupled to the video output of the graphics accelerator 50. The chipset 46 is also coupled to a bus 56 that may be, for example, a Peripheral Component Interconnect bus (PCI) bus. See revision 2.1 of the PCI Electrical Specification available from the PCI Special Interest Group, Portland, Oreg. 97214. The bus 56 connects to a TV tuner/capture card 58 that provides tuning and demodulation for receiving the digital signal. The card 58 may be coupled an antenna 60 or other source of digital video such as a cable input, a satellite receiver or the like.

The bus 56 is also coupled to a bridge 62 that couples the hard disk drive 64 that may store the software 28 and 80 in one embodiment of the present invention. The bridge 62 is also coupled to another bus 66 that may be coupled to a serial input/output (SIO) device 68. In one embodiment of the present invention, the device 68 is in turn coupled to an interface 70 that may be an infrared interface. The interface 70 communicates with a remote control unit 72. Also connected to the bus 66 is a basic input/output system (BIOS) 74.

In some cases, a large amount of content may eventually be downloaded or otherwise acquired and stored in a storage medium associated with the system 10. For example, in conventional systems, the storage medium may be a hard disk drive. Thus, it may be useful for the user to know what content has been stored on the user's hard disk drive. A file may be assembled which gives the user a content guide that lists all the content that is still available for access through the shell 22. In this way, the user can select that content by selecting one of the entries in the content guide. For example, the entries in the content guide may be selected by mouse clicking on them causing the content to immediately begin play.

In one embodiment, the shell 22 may also store the local electronic guide to advertising resources (LEGAR). The LEGAR may be compiled by accessing resources available at the content transmitter 12 to determine the available advertising materials and guidelines for distributing those advertising materials. In one embodiment, the LEGAR may actually include a program of advertising inserts, determined based on information local to the client content receiver 16. In other words, information for the LEGAR may be mined from the receiver 16 based on client user preferences, in a variety of areas, to determine which, of a larger number of potential advertisements available at the transmitter 12, to utilize locally as advertising inserts.

For example, in one embodiment, the advertising that is actually inserted may be targeted to the needs, desires and preferences of the user of a particular client. These preferences, needs, and desires may be determined by monitoring the nature of the material utilized on the client receiver 16. For example, based on information about which web sites are visited, the types of software utilized on the system, and the types of tasks undertaken by the client, a profile may be developed that may be utilized to define the LEGAR among information available at the transmitter 12.

This system may be advantageous in comparison with systems that externally derive information about the client users' activities. In some embodiments, because the information is obtained wholly within the receiver 12 rather than externally therefrom, it may be utilized internally within the client to determine which advertisements to insert. However, the client confidential information need not be accessible externally. In other words, decisions may be made at the client level about which advertisements would be most effective and this information may never be shared with agents outside the client processor-based system. Many users may find this arrangement advantageous. Moreover, advertisers may find it more effective because more information about the user may be derived from within the user's own client.

While a digital receiving system has been described above, the present application is equally applicable to analog systems such as analog television receivers that work with set-top boxes. In such case, storing instructions may be provided over the vertical blanking interval in one embodiment of the present invention. Alternatively, storing instructions may be received over the Internet or through some other source.

In another alternate embodiment, interruption instructions, interrupting content and interruptible content may be received over the Internet 26. In such case, the content may be forwarded through the program guide 24 and directly to the encrypted cache 20. As a result, the content bypasses the tuner/demodulator 18 but still ends up being stored in the encrypted cache 20 as described previously. That information may then be go accessed through the shell 22 in the same way as information stored in the encrypted cache 20 via the tuner/demodulator 18. The interruption instructions may be sent through the program guide 24 to the shell 22.

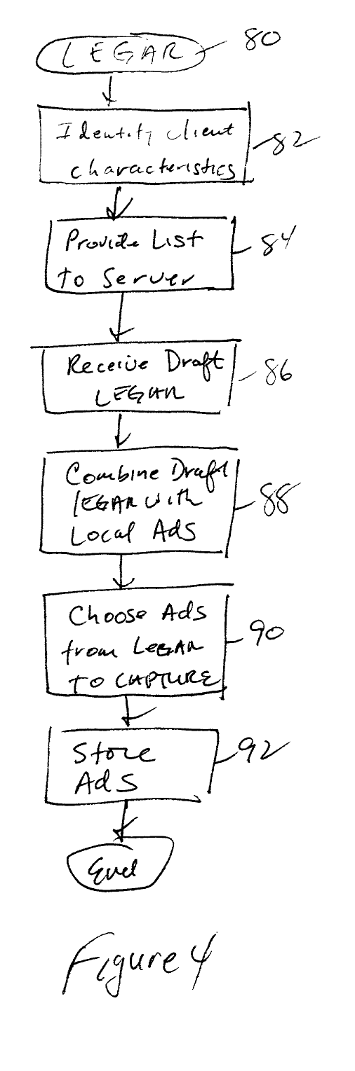

The software 80, shown in FIG. 4, enables a advertising insertion electronic guide to be developed locally within the client based on local preferences, needs and usage patterns. Initially, the software 80 monitors the client characteristics and/or activities as indicated at 82 to derive information about the client's characteristics and the user's needs, preferences and desires. This information may then be transferred to a server as indicated in block 84.

Thereafter, the receiver 16 may receive a database of advertisements that may be termed a draft Local Electronic Guide to Advertising Resources (LEGAR) as shown in FIG. 86. In particular, one or more servers accessible from the client 16 may include a plurality of databases adapted to particular client 16 characteristics. For example, some of the databases may include advertisements in English and others may include advertisements in other languages such as Spanish. Some databases may include advertisements that are suitable for display on particular types of receivers such as radio-equipped receivers, television-equipped receivers, and desktop or laptop computers as opposed to handheld computers, as a few examples. In addition, the databases may be specifically adapted to particular media types or other receiver characteristics.

For any given client 16 to download the entire Global Electronic Guide to Advertising Resources (GEGAR) that may be available on one or more servers, would unduly tax the resources of the connection between the server or servers and the client 16 as well as resources on the client 16 itself. Thus, certain characteristics of the client 16 may be conveyed to one or more servers over an electronic network 10 in order to determine which portions of databases or specific databases should be provided to a particular client 16. In such case, based on these characteristics which are collected on the client 16, the server provides a so-called draft or initial LEGAR as indicated in block 86. The draft LEGAR includes a preliminary set of selections from the GEGAR which are most appropriate given the provided characteristics of the particular client 16. The draft LEGAR may then be combined with any databases already resident on a particular client 16 as indicated in block 88.

From within the combined draft LEGAR, selections may be made of particular advertisements to capture on a particular client 16. These selections may be made in some cases based on particular user patterns, needs, desires, or experience. For example, information may be obtained about the types of websites that a particular client 16 user accesses, the types of files that are resident on the user's client 16, and the frequency with which the user uses the client 16, as examples. The accumulated data may be utilized to determine characteristics of the user and thereby to divine which advertisements within the draft LEGAR are most suitable. For example, if the user has selected particular types of advertisements in the past, in the form of banner ads or other types of advertisements, those types of advertisements may be preferentially selected from within the draft LEGAR as indicated in block 90. The selected advertisements are then stored locally on the client 16 as indicated in block 92.

The selected LEGAR for a particular client 16 is then used by the shell 22 to insert advertisements into content as the content is played. In this way, the resources of the client are not unnecessarily taxed by the need for too large of a database of advertising resources. Moreover, the database that is actually stored locally may be modified to the particular user's needs, desires, and characteristics of a particular client 16.

In some embodiments, the final LEGAR may be stored remotely, such as on a remote processor-based system. The advertisements may then be provided as needed over an appropriate network in one embodiment of the present invention.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
allowing the use of content on a content receiver;
automatically interrupting the use of the content;
enabling the receiver to temporarily replace the content with advertising;
collecting information about a characteristic of a receiver; and
providing that information to a remote processor-based system to select, from an advertising database, an advertising subset for use in connection with the receiver.

2. The method of claim 1 including receiving an advertising database and combining the database with advertising available on the receiver.

3. The method of claim 1 wherein determining information includes monitoring the activities of the user of the receiver.

4. The method of claim 3 wherein determining information includes developing a database of information about activities undertaken by the user of the receiver.

5. The method of claim 4 including selecting advertisements stored on said remote processor-based system based on information about the user of the receiver.

6. The method of claim 5 including compiling a local electronic guide to advertising resources by accessing advertisements available on said remote processor-based system.

7. The method of claim 1 including determining a characteristic of advertising and comparing said characteristic to information about the use of the receiver.

8. The method of claim 1 including enabling a variety of content to be selected for play at any time.

9. The method of claim 1 including automatically replacing the content with advertising after allowing content to be used for a predetermined amount of time.

10. The method of claim 1 including automatically determining at predetermined times whether to replace the content.

11. An article comprising a medium for storing instructions that enable a receiver to:
allow the use of content on the system;
automatically interrupt the use of the content;
enable the system to temporarily replace the content with advertising;
collect information about characteristics of the receiver; and
provide the information to a remote processor-based system to select, from an advertising database, an advertising subset for use in connection with the receiver.

12. The article of claim 11 further storing instructions that enable the receiver to enable a variety of content to be selected for play at any time.

13. The article of claim 11 further storing instructions that enable the receiver to monitor the activities of the user of the receiver.

14. The article of claim 13 further storing instructions that enable the receiver to develop a database of information about activities undertaken by the user of the receiver.

15. The article of claim 14 further storing instructions that enable the receiver to select advertisements stored on the remote processor-based system based on information about the user of the receiver.

16. The article of claim 15 further storing instructions that enable the receiver to compile a local electronic guide to advertising resources by accessing advertising available on the remote processor-based system.

17. The article of claim of 11 further storing instructions that enable the receiver to determine a characteristic of advertising and compare the characteristic to information about the use of the receiver.

18. The article of claim 11 further storing instructions that enable the receiver to automatically replace content with advertising after allowing content to be used for a predetermined amount of time.

19. The article of claim 11 further storing instructions that enable the receiver to automatically determine at predetermined times whether to replace said content.

20. The article of claim 11 further storing instructions that enable the receiver to automatically compile a receiver based database of advertising.

21. A system comprising:
a receiver that receives the transmission of content, said receiver including a shell to enable the use of content to be interrupted and temporarily replaced with advertising; and
storage coupled to said receiver storing instructions that enable said receiver to determine information about the use of the receiver and use the information to select the advertising.

22. The system of claim 21 wherein said system is a television receiver.

23. The storage of claim 21 wherein said receiver automatically replaces the content with advertising after allowing content to be used for a predetermined amount of time.

24. The system of claim 21 wherein said receiver automatically determines at predetermined times whether to replace the content with advertising.

25. The system of claim 21 wherein the receiver enables a variety of content to be selected for play at any time.

26. The system of claim 21 wherein said storage stores instructions that enable the receiver to monitor the activities of the user of the receiver.

27. The system of claim 26 wherein said storage stores instructions that enable the receiver to develop a database of information about activities undertaken by the user of the receiver.

28. The system of claim 21 wherein said storage stores instructions that enable the receiver to access a database of available advertisements on a remote processor-based system.

29. The system of claim 28 wherein said storage stores instructions that enable the receiver to select advertisements stored on said remote processor-based system based on information about the user of the receiver.

30. The system of claim 29 wherein said storage stores instructions that enable the receiver to compile a local electronic guide to advertising resources by accessing advertisements available on the remote processor-based system.
